(19) United States
(12) Patent Application Publication
(10) Pub. No.: US 2025/0253965 A1
(43) Pub. Date: Aug. 7, 2025

(54) ML-BASED FREQUENCY DOMAIN CHANNEL PARAMETER ESTIMATION

(71) Applicant: Qualcomm Incorporated, San Diego, CA (US)

(72) Inventors: Reneeta Sara ISAAC, Bangalore (IN); Sreeram C. SREENIVASAN, Bangalore (IN); Kapil BHATTAD, Bangalore (IN); Gautham HARIHARAN, Sunnyvale, CA (US); Santanu PATTANAYAK, Bangalore (IN); Supratik BHATTACHARJEE, San Diego, CA (US)

(21) Appl. No.: 18/433,138

(22) Filed: Feb. 5, 2024

(51) Int. Cl. H04B 17/391; H04B 17/336; H04L 5/00; H04L 25/02

(52) U.S. Cl. CPC H04B 17/3913; H04B 17/336; H04L 5/0051; H04L 25/0212

(57) ABSTRACT

Certain aspects of the present disclosure provide techniques for obtaining one or more reference signals specific to a communication channel; inputting at least one characteristic associated with the one or more reference signals into a machine learning model that is configured to predict one or more channel parameters associated with multipath propagation characteristics of the communication channel; outputting, from the machine learning model, one or more predicted channel parameters specific to the multipath propagation characteristics of the communication channel; and performing channel estimation to generate a characteristic of the communication channel based on the one or more predicted channel parameters.

### INTRODUCTION

### Field of the Disclosure

Aspects of the present disclosure relate to wireless communications, and more particularly, to techniques for machine learning (ML)-based channel parameter estimation in wireless communication systems.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes obtaining one or more reference signals specific to a communication channel; inputting at least one characteristic associated with the one or more reference signals into a machine learning model that is configured to predict one or more channel parameters associated with multipath propagation characteristics of the communication channel; outputting, from the machine learning model, one or more predicted channel parameters specific to the multipath propagation characteristics of the communication channel; and performing channel estimation to generate a characteristic of the communication channel based on the one or more predicted channel parameters.

Another aspect provides a method for wireless communication by a network entity. The method includes receiving at least one of a predicted delay spread value or PETL value from a UE; and adapting one or more downlink transmission parameters based on the received values.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example artificial neural network architecture.

FIG. 6 depicts an example ML architecture for wireless communications.

FIG. 7 depicts an example system with a first wireless device, second wireless device, and model server.

FIGS. 8A-B depict delay spread concepts and channel impulse response thresholding.

FIGS. 9A-B depict an ML model for predicting delay spread index and PETL, including a neural network implementation.

FIGS. 10A-B depict operations and an architecture for training an ML model to predict optimized delay spread and PETL values.

FIG. 11 depicts a high-speed train single frequency network scenario with time-varying channel characteristics.

FIG. 12 depicts optimizing PETL selection to make delay spread window robust to channel variations during high mobility.

FIG. 13 depicts the UE reporting calculated delay spread and PETL to a base station.

FIG. 14 depicts a method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for ML-based channel parameter estimation in wireless communication systems.

Wireless channel estimation is an important component in wireless communications for accurately characterizing the channel and enabling reliable data transmission. An important aspect to consider when performing channel estimation is delay spread, which can be estimated from reference signals, such as tracking reference signals (TRS), synchronization signal blocks (SSBs), and others. The delay spread represents, among other things, multipath propagation characteristics. Multipath propagation characteristics refer to the time delays associated with different signal reflection/transmission paths between a transmitter and receiver. As signals propagate, they reflect off various objects, refract through different media, or diffuse in multiple directions. These multidirectional paths create multiple versions of the transmitted signal that arrive at the receiver at slightly different times. The time difference between arrival of the first and last multipath component is the delay spread. The communication channel can be modeled as multiple channel estimation filter taps with fading gains and delays matching the multipath characteristics, where a “channel estimation filter tap” refers to each path with a certain delay and fading gain. By determining appropriate tap delays and gains that match the channel, channel estimation can be performed by approximating the channel response as a combination of channel estimation filter taps.

In frequency domain channel estimation techniques, the channel's multipath delay characteristics may be used to determine the number of channel estimation filter taps required. Properly configuring the number of channel estimation filter taps to match the propagation conditions, as indicated by the delay spread, can enable efficient channel estimation.

The delay spread is related to the frequency selectivity of the channel as follows. The higher the delay spread, the higher is the frequency selectivity, i.e., the channel changes faster across frequency. If the delay spread is small, the frequency selectivity is also small, i.e., the channel doesn't change much across frequency; correlation across frequency changes slowly. Estimating the delay spread accurately is important to characterize the frequency selectivity of the channel. Accounting for either insufficient number of taps or excessive number of taps in the delay spread, can disrupt the correlation characteristics of the channel and lead to channel estimation errors.

When performing channel estimations in the frequency domain as discussed previously, the channel may be approximated as a linear combination of columns of a uniform basis matrix, where the basis matrix is derived based on the assumption that the power-delay profile is uniform over the length of the delay spread. In other words, the uniform power-delay profile assumes that all channel estimation filter taps have equal gain over the length of the delay spread. This assumption simplifies the channel estimation. The basis matrix, hence, is a function of the delay spread of the channel. The basis matrix as a whole represents a set of frequency responses that can be linearly combined to approximate an overall channel frequency response for a given value of delay spread.

A delay spread index, based on the delay spread, is used to choose a particular basis matrix to match the channel characteristics. In examples, a delay spread index is used to bin a range of delay spread values to a given value. For example, a delay spread ranging from 0 to 0.1 ms can be binned to delay spread index 0; a delay spread ranging from 0.1 to 0.5 ms can be binned to delay spread index 1 and so on. In certain aspects, the maximum value in the range for each delay spread index can be used to derive the basis matrix for that delay spread index.

Delay spread estimation techniques utilized for channel estimation in wireless communication networks generally utilize preset heuristics and thresholds to distinguish channel estimation taps with significant energy from noise. However, these preset heuristics and thresholds do not adapt well to diverse real-world channel characteristics. These fixed heuristics and thresholds fail to adjust across differing signal propagation environments encountered in a wireless network environment. Extensive tuning of the preset heuristics and thresholds may be needed to handle a range of bandwidths, device types, and deployment scenarios.

To address these limitations, aspects of the present disclosure are directed to an ML model trained to predict a delay spread index and projected energy tracking loop (PETL) values for diverse channel conditions, where the delay spread index predicts a basis matrix selection representing a delay profile characterization and the PETL value represents an optimal shifting amount of a delay spread window. Rather than using heuristics and thresholds, the ML model directly optimizes channel estimation accuracy by mapping channel feature inputs to delay spread and PETL parameters minimizing channel estimation error. The flexible ML-based methodology improves performance gains in the wireless network environment without the overhead of manual parameter tuning.

In certain aspects, the ML model takes as input a reference signal energy profile, which can be the signal energy taps of the TRS channel impulse response. In aspects, the signal energy tap is the reference signal energy measured for an individual multipath component's contribution to the overall channel impulse response, where the full signal energy profile across signal energy taps becomes the input to the ML model. In certain aspects, the ML model may take as input a noise energy level associated with one or more reference signals, an indicator specifying whether inputs are from TRS or a SSB, MCS, rank, beamforming/precoding state, Doppler shift, and/or DMRS pattern density. Using one or more of the inputs, the ML model predicts a delay spread (e.g., delay spread index) that maps to a selection of an optimal basis matrix covering the channel taps for estimation. In certain aspects, the ML model predicts a PETL value to determine an optimal shifting amount of a centered delay spread window to capture channel tap energy.

By training over many randomized channel profiles modeling a wide range of real-world multipath combinations, the ML model is trained to map inputs to delay parameters that maximize channel estimation accuracy. This avoids reliance on heuristics unable to adapt across diverse deployments.

In certain aspects, an ML model is trained on extensive channel profile datasets to predict optimized delay spread (e.g., delay spread index) and PETL values that minimize channel estimation error. In certain aspects, the ML model inputs include one or more of reference signal energy, noise energy, Doppler shifts, and indicators specifying the reference signal type (TRS or SSB). By training on randomized channel data, the model learns to effectively adapt delay spread and PETL calculations to diverse real-world conditions. This avoids reliance on preset heuristics and thresholds that fail to generalize. The flexible machine learning approach improves efficiency and accuracy versus conventional channel estimation.

The ML-based channel parameter estimation may be particularly beneficial for certain environments, such as high-mobility use cases like high-speed rail networks. In such cases, the ML model utilizes indicators such as Doppler shifts to dynamically tune delay calculations based on channel variability. The framework also supports retraining the model on new collected data, continually improving accuracy. Further, multiple models can be created for different parameters like bandwidth device types. That is, channel settings can be based on outputs from the ML model to optimize channel estimation performance across varying signal propagation characteristics.

ML-based channel parameter estimation also supports retraining the ML model on newly collected channel data to continually improve accuracy over time. Further, on or more ML models can be created that are optimized for different bandwidths, device types, ranks etc. The ML models provide optimized delay spread and PETL value outputs that adapt channel estimation to varying channel propagation characteristics. This enables efficient channel approximation across diverse real-world conditions.

In one example, certain aspects are directed to an apparatus that obtains reference signals associated with a communication channel and inputs characteristics of the signals into a machine learning model that predicts channel parameters related to multipath propagation characteristics. In certain aspects, the model outputs optimized delay spread and PETL values that are matched to the communication channel through training that minimizes estimation error. Channel estimation is performed using the model outputs. The ML-based channel estimation avoids reliance on fixed heuristics, improving accuracy across mobility conditions and deployments.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

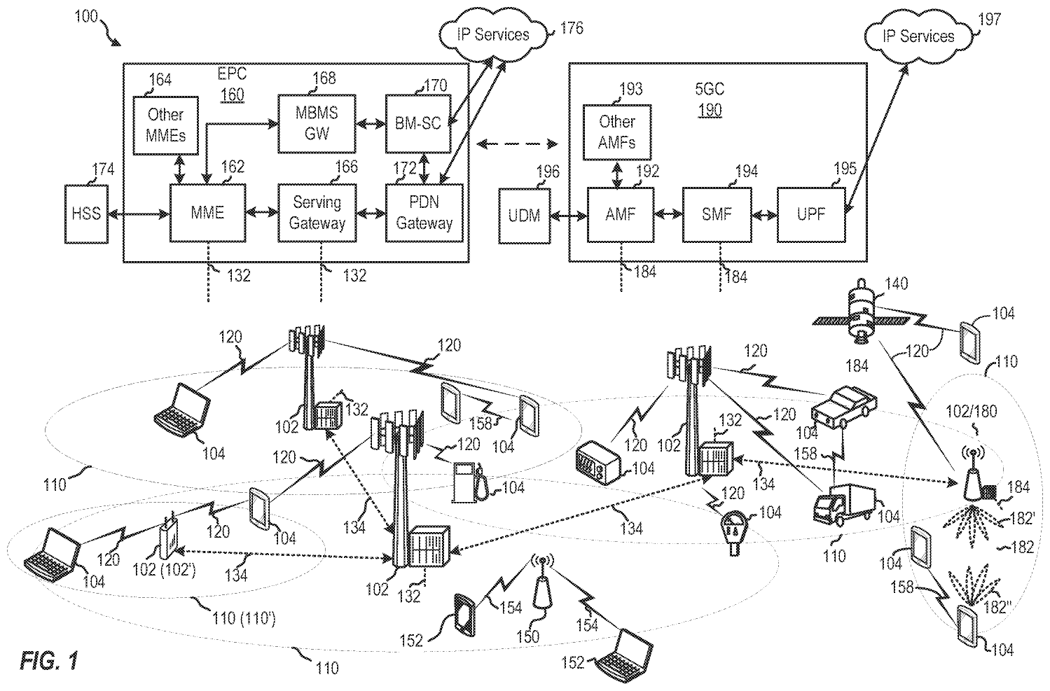

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

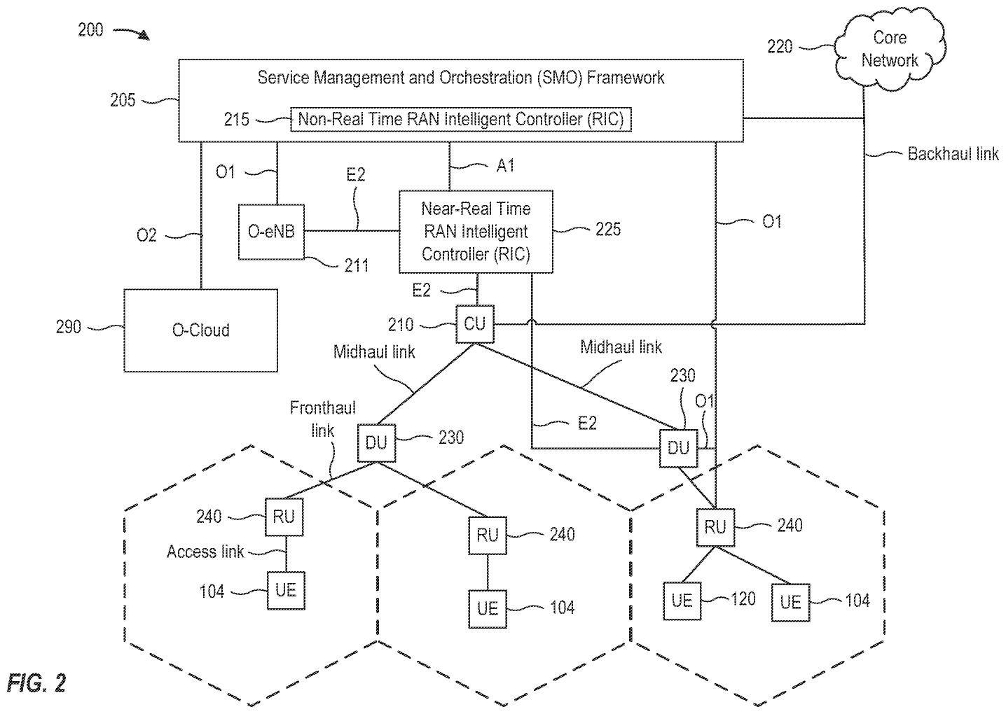

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

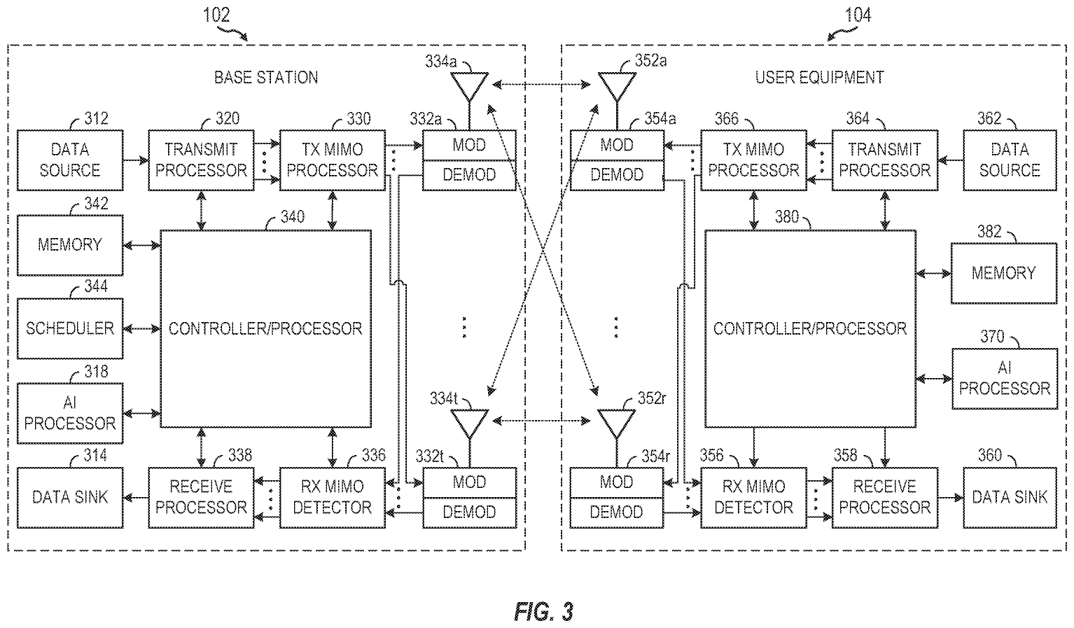

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

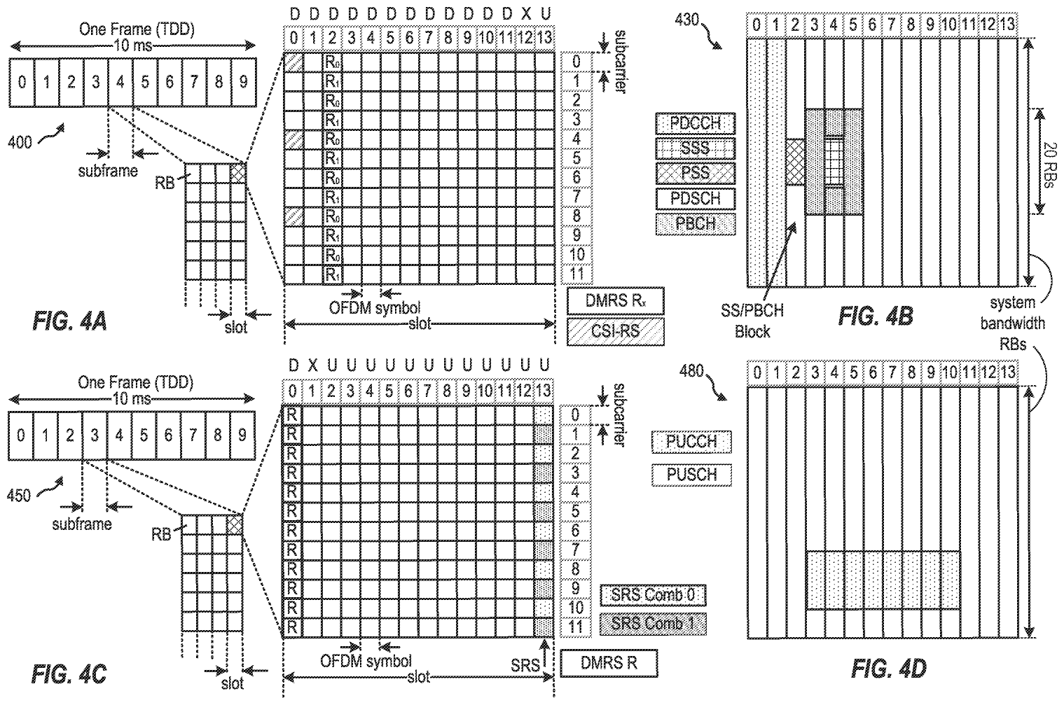

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence Model

Certain aspects and techniques as described herein may be implemented, at least in part, using an ML model, such as a program based on an ANN. An ANN is an example of an ML model architecture. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless channel parameter estimation in 5G NR systems. Such an ML model may be configured with weights and biases to perform optimizing the selection of delay spread and PETL values to minimize channel estimation error. Thus, during operation of a user equipment (UE), the ML model may receive input data (such as reference signal energy, noise energy, Doppler shifts) and make inferences (such as predicted delay spread index selecting an optimal basis matrix for estimation and PETL value specifying an amount of shift applied to a window to cover one or more taps) based on the weights and biases.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. For example, a classification ML model configured according to aspects of this disclosure may produce an output which could include a predicted delay spread (e.g., delay spread index). A regression ML model configured according to embodiments of this disclosure may produce an output which could include a predicted PETL value. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc. In some aspects of this disclosure, one advantageous ML model for processing the input data is a convolutional neural network, in which the CNN may improve the efficiency of processing the input data by extracting features related to channel conditions to achieve minimized channel estimation error.

The description herein illustrates, by way of some examples, how one or more tasks or problems in wireless communications may benefit from the application of one or more ML models to improve the accuracy of delay spread (e.g., delay spread index) and PETL estimation for channel estimation. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

### ML Model Architecture Examples

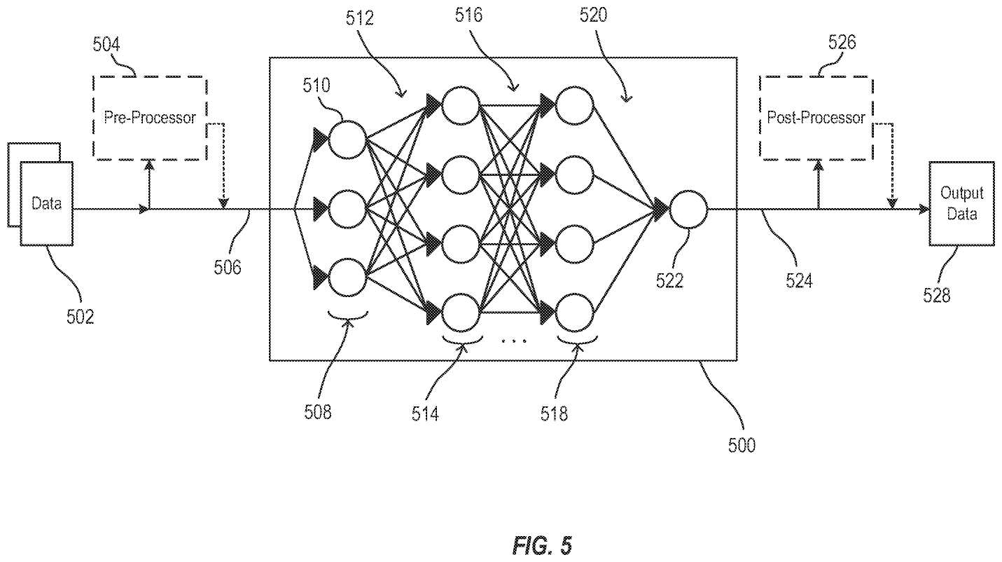

FIG. 5 is an illustrative block diagram of an example ML model represented by an ANN 500.

ANN 500 may receive input data 506 which may include one or more bits of data 502, pre-processed data output from pre-processor 504 (optional), or some combination thereof. Here, data 502 may include training data, verification data, application-related data, or the like, based, for example, on the stage of deployment of ANN 500. Pre-processor 504 may be included within ANN 500 in some other implementations. Pre-processor 504 may, for example, process all or a portion of data 502 which may result in some of data 502 being changed, replaced, deleted, etc. In some implementations, pre-processor 504 may add additional data to data 502. In some implementations, the pre-processor 504 may be a ML model, such as an ANN. In some examples, the pre-processor 504 may generate reference signal energy normalizations, noise energy normalizations, or perform feature extractions from a channel profile data.

ANN 500 includes at least one first layer 508 of artificial neurons 510 to process input data 506 and provide resulting first layer data via connections or “edges” such as edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof.

Post-processor 526 may be included within ANN 500 in some implementations. Post-processor 526 may, for example, process all or a portion of output data 524 which may result in output data 528 being different, at least in part, to output data 524, as result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be a ML model, such as an ANN. In some examples, the ANN 500 outputs predicted delay spread (e.g., delay spread index) and PETL values; the post-processor 526 may operate on these predicted delay spread (e.g., delay spread index) and/or PETL values to format or quantify such values or perform a model accuracy assessment to assess ML model accuracy.

The structure and training of artificial neurons 510 in the various layers may be tailored to specific requirements of an application. Within a given layer such as first layer 508, second layer 514, or third layer 518 of ANN 500, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer.

Artificial neurons in such a layer may be activated by or be responsive to parameters such as the previously described weights and biases of ANN 500. The weights and biases of ANN 500 may be adjusted during a training process or during operation of ANN 500. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 506. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 500, may be conducted using training data. Training data may include one or more datasets which ANN 500 may use to identify patterns or relationships. Training data may represent various types of information, including written, visual, audio, environmental context, operational properties, etc. During training, the parameters (such as the weights and biases) of artificial neurons 510 may be changed, such as to minimize or otherwise reduce a loss function or a cost function. A training process may be repeated multiple times to fine-tune ANN 500 with each iteration.

Various ANN model structures are available for consideration. For example, in a feedforward ANN structure, each artificial neuron 510 in layer 514 receives information from the previous layer (such as, one or more artificial neurons 510 in layer 508) and produces information for the next layer (such as, one or more artificial neurons 510 in layer 518). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting. In certain aspects, a convolutional neural network structure with multiple hidden layers is described in this disclosure as a particular ANN architecture used for the delay spread and PETL prediction model.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 500 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

### Model Training Examples

In example aspects, an ML model may be trained prior to, or at some point following, operation of the ML model, such as ANN 500, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. In examples, supervised training data may include channel profile datasets containing reference signal energy, noise energy, and Doppler shifts as inputs and optimized delay spread index and PETL values as target labels that minimize channel estimation.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model. The UE 104 and base station 102 can work together by having the UE 104 report delay spread (e.g., delay spread index) and PETL values predicted by the locally trained ML model to the base station 102. The base station 102 can utilize these predicted parameters to adapt downlink transmission schemes. Over time, the UE 104 and base station 102 can benefit from improvements to the shared ML model through aggregated model updates.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

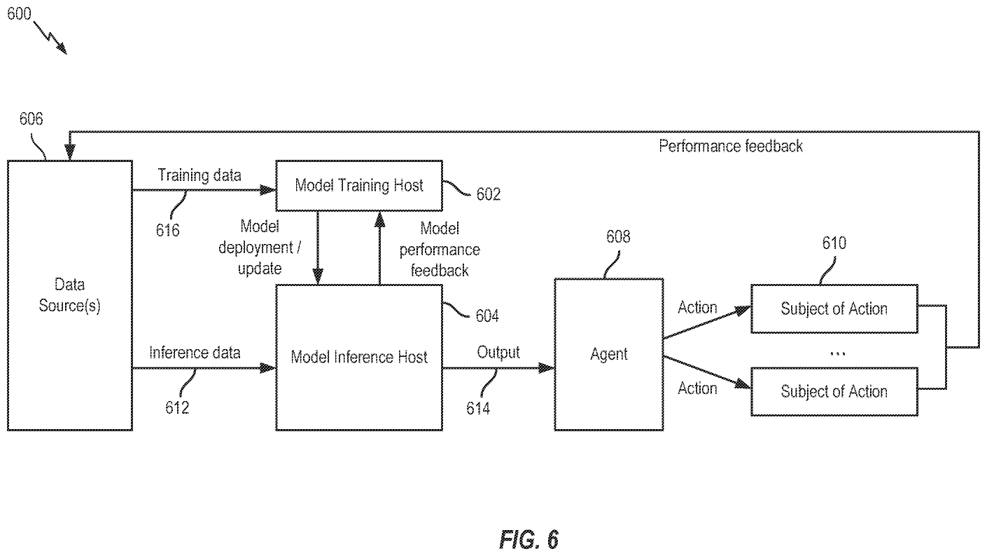

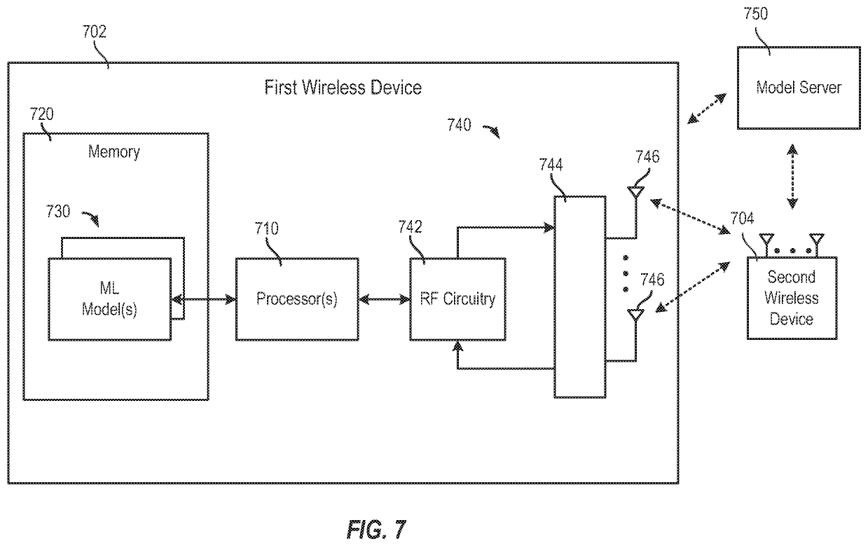

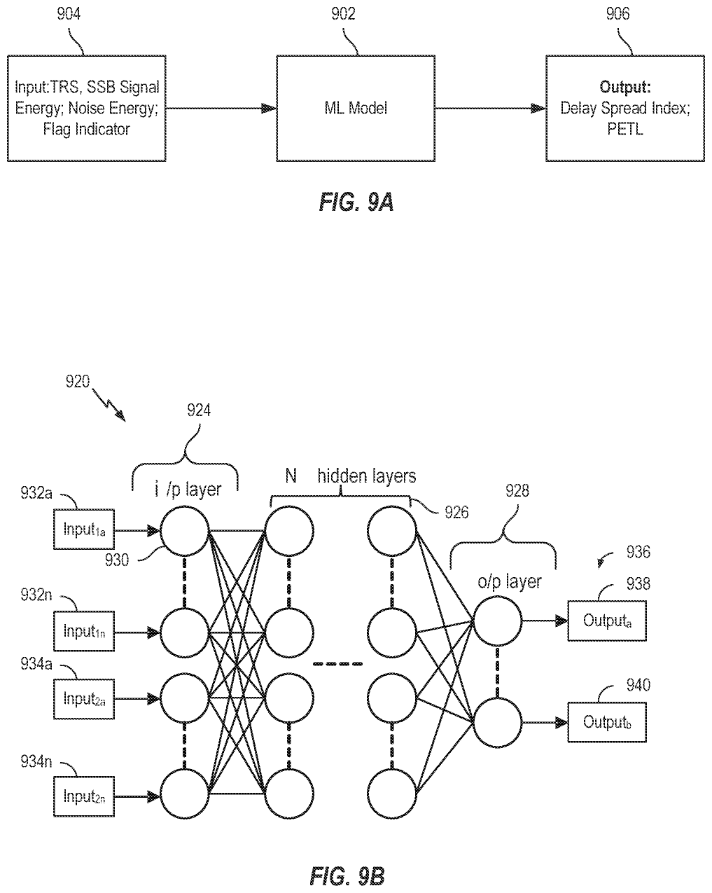

FIG. 6 is an illustrative block diagram of an example ML architecture 600 that may be used for wireless communications in any of the various implementations, processes, environments, networks, or use cases listed above. As illustrated, ML architecture 600 includes multiple logical entities, such as model training host 602, model inference host 604, data sources 606, and agent 608. Model inference host 604 is configured to run an ML model based on inference data 612 provided by data sources 606. Example inputs for the ML model include reference signal energy, noise energy, Doppler shifts, channel rank, modulation and coding schemes, etc. Leveraging these inputs, the ML model produces outputs 614 containing predicted delay spread (e.g., delay spread index) and PETL values. Model inference host 604 may produce output 614, which may include a prediction or inference, such as a discrete or continuous value based on inference data 612, which may then be provided as input to the agent 608. In accordance with certain aspects, FIG. 6 illustrates an example ML architecture 600 that can be used for training and deploying the machine learning model for delay spread (e.g., delay spread index) and PETL prediction. The model training host 602 performs model development workflows including training based on extensive channel profile datasets from data sources 606. The optimized model is deployed on the model inference host 604, which utilizes the model to generate delay spread (e.g., delay spread index) and PETL predictions as output 614 for the agent 608 representing the user equipment leveraging these parameters for channel estimation as described with respect to FIG. 9A. FIG. 7 provides additional details of an example system for model training, deployment and utilization between user equipment and base stations.

Agent 608 may represent an element or an entity of a wireless communication system including, for example, a RAN, a wireless local area network, a device-to-device (D2D) communications system, etc. As an example, agent 608 may be a user equipment, such as UE 104 for example, a base station such as BS 102 for example, or a disaggregated network entity such CU 210, a DU 230, or an RU 240, an access point, a wireless station, a RAN intelligent controller (RIC) in a cloud-based RAN, among some examples. Additionally, agent 608 also may be a type of agent that depends on the type of tasks performed by model inference host 604, the type of inference data 612 provided to model inference host 604, or the type of output 614 produced by model inference host 604.

The agent 608 may be a UE and the output 614 may include predicted delay spread (e.g., delay spread index) and PETL values for channel estimation.

Agent 608 may perform one or more actions associated with receiving output 614 from model inference host 604. The agent 608, as a UE, may utilize the predicted delay spread (e.g., delay spread index) and PETL values to perform channel estimation and request the subject of action 610, a BS, to adapt downlink transmission parameters based on the channel conditions. Agent 608 may indicate the one or more actions performed to at least one subject of action 610. As an example, the agent 608 may be a UE, the output 614 from model inference host 604 may be one or more predicted channel characteristics for one or more beams. For example, the model inference host 604 may predict channel characteristics for a set of beams based on the measurements of another set of beams. Here, the outputs 614 may be the optimized delay spread (e.g., delay spread index) and PETL values predicted by the machine learning model which are provided as input to the agent 608 for channel estimation. Based on the predicted channel characteristics, the agent 608, such as the UE, may send to the subject of action 610, such as a BS, a request to switch to a different beam for communications. In some cases, the agent 608 and the subject of action 610 are the same entity.

Data can be collected from data sources 606, and may be used as training data 616 for training an ML model, or as inference data 612 for feeding an ML model inference operation. Data sources 606 may collect data from various subject of action 610 entities (such as, the UE or the network entity), and provide the collected data to a model training host 602 for ML model training. In certain aspects, the training data 616 comprises channel profiles including parameters like reference signal energy, noise energy, and Doppler shifts to train the delay spread (e.g., delay spared index) and PETL prediction models. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a beam configuration from agent 608, the subject of action 610 may provide performance feedback associated with the beam configuration to the data sources 606, where the performance feedback may be used by the model training host 602 for monitoring and/or evaluating the ML model performance, such as whether the output 614, provided to agent 608, is accurate. In some examples, if output 614 provided to agent 608 is inaccurate (or the accuracy is below an accuracy threshold), model training host 602 may provide feedback to model inference host 604 to modify or retrain the ML model used by model inference host 604, such as via an ML model deployment update.

Model training host 602 may be deployed at the same or a different entity than that in which model inference host 604 is deployed. For example, in order to offload model training processing, which can impact the performance of model inference host 604, model training host 602 may be deployed at a model server.

In some aspects, an ML model is deployed at or on a network entity (such as BS 102) for delay spread (e.g., delay spread index) and PETL prediction to adapt downlink transmission parameters. More specifically, a model interference host, such as model inference host 604 in FIG. 6, may be deployed at or on the network entity for such delay spread (e.g., delay spread index) and PETL prediction to adapt downlink transmission parameters.

In some other aspects, an ML model is deployed at or on a UE (such as UE 104) for delay spread (e.g., delay spread index) and PETL prediction for channel estimation. More specifically, a model inference host, such as model inference host 604 in FIG. 6, may be deployed at or on the UE for delay spread (e.g., delay spread index) and PETL prediction for channel estimation.

The ML model for delay spread (e.g., delay spread index) and PETL prediction is collaboratively deployed across the UE and BS. The UE utilizes the locally deployed model to predict optimized parameters and reports them to the BS to adapt downlink transmission. The BS and UE collaborate to continually improve model accuracy through aggregated model updates from a central server.

FIG. 7 is an illustrative block diagram of an example ML architecture of first wireless device 702 in communication with second wireless device 704. The first wireless device 702 may be the UE 104 as described herein with respect to FIGS. 1 and 3. Similarly, the second wireless device 704 may be the BS 102 or a disaggregated network entity thereof as described herein with respect to FIGS. 1-3. Note that the example ML architecture of first wireless device 702 may be applied to second wireless device 704, and vice versa.

First wireless device 702 may be, or may include, a chip, system on chip (SoC), chipset, package or device that includes one or more processors, processing blocks or processing elements (collectively “processor 710”) and one or more memory blocks or elements (collectively “memory 720”). Processor 710 may be coupled to transceiver 740, which includes radio frequency (RF) circuitry 742 coupled to antennas 746 via interface 744, for transmitting or receiving signals.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

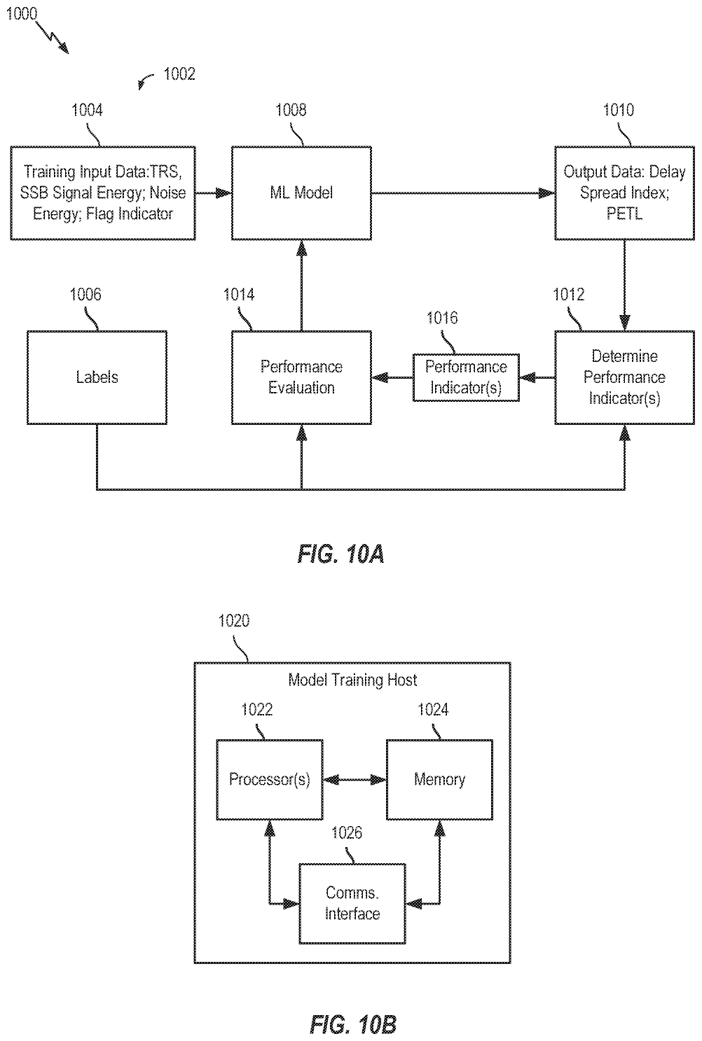

As illustrated in FIGS. 10A-B, the initially trained delay spread (e.g., delay spread index) and PETL prediction models can be retrained by a model training host on newly collected channel data to enhance performance. This process is represented in FIG. 7 through the model server 750, which collects data to retrain the ML models 730 and deploy improved versions back to the wireless devices like the first wireless device 702. By periodically retraining on additional channel statistics, the model server enables continual enhancement of the delay spread (e.g., display spread index) and PETL prediction models to better match evolving real-world signal environments.

The processor 710 may use the ML model 730 to produce output data (e.g., the 614 of FIG. 6) based on input data (e.g., the inference data 612 of FIG. 6), for example, as described herein with respect to the model inference host 604 of FIG. 6. The ML model 730 may be used to perform any of various AI-enhanced tasks, such as those listed above. Here, the ML model 730 outputs the predicted delay spread (e.g., delay spread index) and/or PETL value based on inputs like reference signal energy and noise profile data.

In certain aspects, the model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 to collect and host training data, inference data, and/or performance feedback associated with an ML model 730. In certain aspects, the model server 750 may host various types and/or versions of the ML models 730 for the first wireless device 702 and/or the second wireless device 704 to download.

In some cases, the model server 750 may monitor and evaluate the performance of the ML model 730 to trigger one or more LCM tasks. For example, the model server 750 may determine whether to activate or deactivate the use of a particular ML model at the first wireless device 702 and/or the second wireless device 704, and the model server 750 may provide such an instruction to the respective first wireless device 702 and/or the second wireless device 704. In some cases, the model server 750 may determine whether to switch to a different ML model 730 being used at the first wireless device 702 and/or the second wireless device 704, and the model server 750 may provide such an instruction to the respective first wireless device 702 and/or the second wireless device 704. This allows continual enhancement of the initially delay spread (e.g., display spread index) and PETL prediction models used by the UE for channel estimation. In yet further examples, the model server 750 may also act as a central server for decentralized artificial intelligence tasks, such as federated learning.

### Delay Spread and PETL Estimation

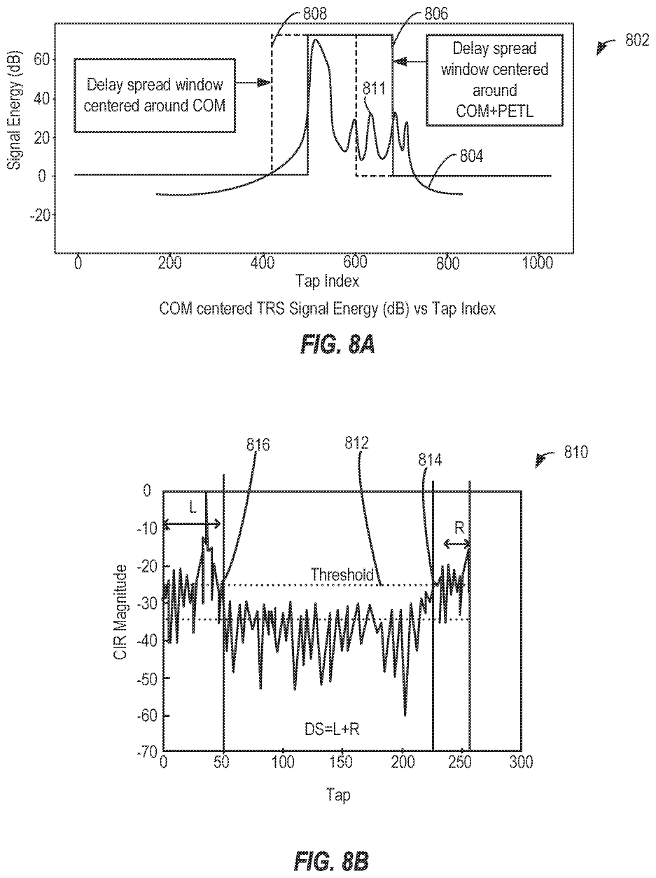

FIG. 8A depicts aspects related to delay spread and power delay profile estimation in a wireless communication system. The graph 802 illustrates a delay spread window 808 for a channel impulse response (CIR) signal 804. The x-axis represents tap index and the y-axis shows CIR magnitude in dB. The delay spread window 808 can be used to determine the number of channel taps that will be used for channel estimation. As depicted in the graph 802, the delay spread window 808 is centered on the center of mass (COM) of the signal 804 without any shift, indicating that the signal energy distribution is across the corresponding tap indices (e.g., dB versus tap index).

However, as shown in FIG. 8A, the delay spread window 808 may not initially capture all the significant energy taps. Some weaker taps (e.g., 811) can still contain meaningful channel information but fall outside the centered delay spread window 808. In examples, the delay spread window 808 can be shifted as depicted by the delay spread window 806 to better capture significant channel taps. That is, the delay spread window 806 may be centered around COM and a PETL value, where the PETL value is used to determine the amount of shift to be applied to the centered delay spread window 808 in order to better capture significant channel taps. The PETL value are used to re-center the delay spread window 808 to 806.

By shifting the originally COM-centered delay spread window 808 to 806 via the PETL value, the adjusted delay spread window 806 can cover more of the significant channel taps. This improves channel estimation accuracy by better matching to current channel conditions. That is, shifting the delay spread window by centering the window around COM+PETL in the tap domain is equivalent to applying a phase ramp in frequency domain. The phase ramp can be applied to the basis matrix during channel estimation. In other words, the basis matrix is rotated by an amount of this shift. However, current techniques to determine delay spread and PETL rely on fixed heuristics and thresholds that remain static. For example, delay spread may be selected based on a channel impulse response using a preset noise threshold. Delay spread estimated using such preset noise thresholds and PETL may fail to track channel variability in real world wireless network environments.

Accordingly, to overcome the shortcomings of conventional approaches, an ML approach can be used to train one or more ML models to predict delay spread (e.g., delay spread index) and PETL values based on signal conditions such that the adjusted delay spread window 806 can cover more of the significant channel taps based on ML predicted delay spread and PETL values. The predicted PETL value that is used to shift the delay spread window is used to rotate the basis matrix. The ML model can be trained on channel data to directly minimize an error metric like normalized mean square error (NMSE) between actual and estimated channel conditions across varying scenarios The delay spread index and PETL value that provides the least NMSE of the channel estimate are used as target labels for a given channel impulse response. The ML model is thus, trained to predict optimal delay spread values (e.g., delay spread index selecting an appropriate basis matrix) as well as an optimal PETL value that specifies rotation to apply to the selected basis matrix in the frequency domain that minimizes channel estimation error. By determining an appropriate basis matrix and also the rotation factor of the basis matrix to match current propagation conditions, the channel estimates can be enhanced.

By learning complex real-world channel characteristics, an ML model can generalize effectively across diverse propagation environments. For example, the ML model can learn to determine the length of the delay spread window and shift it appropriately based on current tap distributions, avoiding reliance on preset heuristics using fixed windows. In examples, the ML model can also be retrained, such as described (generally) with respect to FIG. 6, on an ongoing basis as more channel data is collected on deployed networks and devices. Accordingly, in some examples, the ML model can be adapted to future channel estimation algorithms. For example, using non-uniform power delay profiles involves retraining on a new basis set while retaining the same or similar model framework. Rather than relying on preset heuristics, the ML model described herein is trained to predict optimized delay spread (e.g., delay spread index) and PETL values based on input signal conditions to minimize channel estimation error.

FIG. 8B depicts a graph 810 which shows a channel impulse response and illustrates thresholds used to heuristically select channel taps with significant energy that should be included in the delay spread window 806. Here, a channel tap refers to a signal path with associated delay and fading gain, which contributes to the overall CIR. The length of the CIR is 256 taps. The CIR magnitude plot shows an example threshold level 812 that distinguishes lower-energy noise taps from higher-energy signal taps. The delay spread is calculated, in this example, as the spread between the first tap 814, which is tap index 225, and the last tap 816, which is tap index 50, that falls above threshold. Hence, DS=L+R, where L=50-0, and R=256-225. However, the optimal threshold can vary substantially across deployment profiles, requiring extensive parameter tuning in the field to avoid missing channel dynamics in a given environment.

A technical advantage and effect of the proposed ML based approach is the ability to learn appropriate criteria for selecting which taps should be included in the delay spread window alleviating manual threshold adjustment. By directly optimizing channel estimation error (e.g., NMSE) during training over randomized channel conditions, the ML model can adapt various signal, noise, and interference thresholds to determine which taps contain useful energy versus noise to include. Thus, the training of the ML model can cover a range of possible delay spread indices (representing different sets of included taps), with a target label chosen as the delay spread index that minimizes estimation error (e.g., NMSE). The same methodology can apply for PETL value selection, with the optimal offset found within a search range (−2 microseconds to 2 microseconds for example) that keeps the window centered on dominant channel energy.

Rather than relying on preset thresholds, the proposed ML model is trained on channel profiles to learn to select taps and delay spread window parameters. By directly minimizing channel estimation error during training, the ML model can effectively adapt thresholds across diverse channel conditions. While current channel estimators assumes a uniform power delay profile, the ML model approach can utilize various channel measurements with different distributions of tap energies and delays. The input feature set provided to the model can be augmented with supplemental indicators that help estimate the current tap distribution to tune selections accordingly. For example, scheduled MCS, UE environment, beamforming state, Doppler shift and configured DMRS density provide additional context on the propagation conditions that may govern optimal tap thresholds. By training over randomly generated channel profiles with varying thresholds, the machine learning model learns appropriate criteria for selecting significant taps and rejecting noisy taps to minimize channel estimation error.

FIG. 9A illustrates a data flow for an ML model 902 that can be used for predicting delay spread (e.g., delay spread index) and PETL for channel estimation, such as shown in FIG. 7. Specifically, the ML model 902 depicts one possible neural network implementation for predicting the delay spread (e.g., delay spread index for a basis matrix) and PETL value for frequency domain channel estimation in wireless communication systems. As shown, the ML model 902 takes as input 904 reference signal energy, noise energy, and an indicator specifying whether the reference signal is TRS or SSB.

The ML model 902 may be trained to predict (e.g., output 906) optimal delay spread (e.g., delay spread index) and PETL values for accurate channel estimations. For example, the delay spread index may select amongst uniform power delay profile basis matrices assumed in the channel estimation algorithm. The PETL value determines shifting of the centered delay spread window to capture significant channel taps. As channel characteristics can vary across different frequency bandwidths and deployments, multiple models can be trained for different bandwidths, subcarrier spacings, ranks, and other parameters.

FIG. 9B illustrates an example neural network 920 that serves as one implementation of the ML model 902 shown in FIG. 9A for predicting optimized delay spread (e.g., delay spread index) and PETL. Neural network 920 contains an input layer 924 for receiving model inputs, multiple hidden layers 926 for feature extraction, and an output layer 928 for generating the target predicted parameters. The various layers of the neural network 920 are trained to extract features from the input reference signal and noise energy profiles that are predictive of the delay spread and PETL parameters that will minimize channel estimation error. The number of layers and number of neurons 930 are tuned based on the complexity required to map inputs to output delay spread and PETL predictions.

The input layer 924 receives inputs 932a, 932n, 934a, and 934n which could be reference signal energy, noise energy, and/or an indicator specifying whether the input energy corresponds to TRS or SSB. The length of the input signal and noise energy vectors can match the maximum supported transform precoding size, such as 1024 for 100 MHz bandwidth. The TRS/SSB indicator provides an indication to the model that different subsets of training data apply for the two reference signal types.

The hidden layers 926 process the input data to extract latent features relevant for predicting the channel parameters. The number of hidden layers can be optimized based on the complexity required to map inputs to outputs. More hidden layers enable capturing higher-order feature interactions. Various activation functions like rectified linear units and leaky rectified linear units can be used within the hidden layers 926 to enable complex nonlinear processing.

The output layer 928 generates one or more outputs 936 that can include a predicted delay spread values (e.g., delay spread index) 938, a PETL value 940 (e.g., and/or a basis matrix rotation value) based on the computations through the neural network 920. The delay spread index maps to selection of an appropriate basis matrix for frequency domain channel estimation. The PETL value determines shifting the centered delay spread window to capture significant channel taps.

The neural network 920 can be trained through standard supervised learning techniques based on channel profile datasets. By training to minimize channel estimation error metrics, like normalized mean squared error, the model learns to predict delay spread (e.g., delay spread index) and PETL values that directly improve channel estimation accuracy under various conditions. Retraining enables adaptation to newer data.

Specific neural network architectures can be created for different bandwidths, subcarrier spacings, ranks, and so on. Multiple models focused on specific parameter sets enables tailored optimization to those use cases for enhanced performance. The overall methodology centered on using ML to predict channel parameters can apply across the range of models. The structured training process allows retraining on new channel data, enabling continual enhancements of the model to evolve with real-world conditions.

### Model Training Methodology

FIG. 10A illustrates an example training process 1000 for training an ML model 1008 to predict optimized delay spread (e.g., delay spread index) and PETL values to enable accurate frequency domain channel estimation in wireless systems, as discussed in the earlier figures. The training process 1000 may be executed on a model training host 1020 such as a server containing channel profile datasets and computational capacity for machine learning model development.

The model training host 1020 initially obtains training data 1002 to train the ML model 1008. The training data 1002 comprises multiple sets of input data 1004 and corresponding target output labels 1006. The input data 1004 includes parameters impacting channel environment and estimation performance, and can include reference signal energy, noise energy, and indicator flags specifying whether the input energy corresponds to TRS or SSB reference signals.

The accompanying target labels 1006 provide the optimal delay spread (e.g., delay spread index) to select an appropriate basis matrix and PETL values between-2 to 2 microseconds that minimize channel estimation error for each set of input data 1004 under the associated channel conditions. By training the ML model 1008 to predict the target delay spread and PETL values based on the inputs, the ML model 1008 can learn to estimate optimized delay spread and PETL values dynamically across varying channel conditions.

In certain aspects, the model training host 1020 inputs the training data into the ML model 1008 in small iterative batches, one batch at a time. Based on each input data 1004, the ML model 1008 predicts corresponding delay spread (e.g., delay spread index) and PETL values as model outputs 1010. The modeling training host 1020 then compares the model outputs 1010 against the target labels 1006 to compute 1012 one or more performance indicators 1016 measuring channel estimation accuracy, such as NMSE. The modeling training host 1020 performs a performance evaluation 1014 to evaluate whether the model outputs 1010 meet defined accuracy criteria for the performance indicators 1016 over the training dataset. If the criteria are not achieved, the model training host 1020 updates the ML model parameters using gradient descent based optimizers to minimize the estimation error loss. The updated model is then utilized in the next round of training data batch processing. As the training process 1000 continues over many iterations encompassing the entire channel profile dataset, the ML model 1008 incrementally enhances its ability to predict optimized delay spreads and PETL values for accurate channel estimation across a wide range of signal environments matching real-world conditions. Once the performance criteria are met, the model has achieved generalization.

While the base training process utilizes NMSE as the performance indicator 1016 and optimization criteria, multiple specialized ML models can be created focused on different bandwidths, device types etc. Different performance indicators 1016 can be used for training including Log likelihood (LLR) quality, BER etc. to better correlate the model outputs with end application requirements beyond just channel estimation error. The trained ML models enable real-time dynamic prediction of optimized delay spread (e.g., delay spread indices) and PETL values which provide computational efficiency gains over thresholding-based techniques. Periodic retraining on new collected channel data allows continually enhancing model robustness to evolving real-world signal environments. Retraining also enables adaptation of baseline models optimized for specific bandwidths or device types to newer scenarios. The training data composition and performance indicators 1016 can be tuned during retraining to meet requirements of new deployments, while retaining the fundamental ML-based architectural framework for predicting channel parameters. While the FIG. 10A focuses on delay spread and PETL prediction, the model training is also applicable when utilizing machine learning for other wireless communication processing objectives such as beam selection, signal classification etc. The models can predict optimal parameters or actions to optimize a defined performance indicator suitable for the intended functionality.

FIG. 10B illustrates implementation details of a model training host 1020, such as model training host 602, that executes the training process 1000 for the ML model 1008 shown in FIG. 10A to predict optimal delay spread and PETL values based on input reference signal energy and noise characteristics. The model training host 1020 includes one or more processors 1022, memories 1024, and communication interfaces 1026 enabling wired or wireless data exchange. The model training host 1020 represents an example platform that executes the training process 1000 to develop the machine learning models which predict delay spread and PETL values minimizing channel estimation error.

The host's components 1022, 1024, and 1026 facilitate acquiring channel profile datasets from external sources via communication interfaces 1026. The datasets are stored in the memories 1024. The instructions encoded in the memories configure the processors 1022 to perform model training operations by executing the training process 1000 as illustrated in FIG. 10A. Specifically, the processors 1022 input training data into ML models, evaluate model performance using channel estimation accuracy metrics, and dynamically update model parameters until optimization criteria are met to minimize prediction error across channel environments modeled in the training data. The optimized model is then deployed.

In certain deployment scenarios, multiple modeling training hosts 1020 can coordinate via their communication interfaces 1026 to distribute training across datasets best suited for their wireless coverage zones and then aggregate the optimized models to achieve localization. The model training host 1020 is representative of various computational platforms capable of executing ML workflows comprising data ingestion, preprocessing, model development including training/retraining, testing, analysis, and deployment. These can include servers, personal computers, cloud instances etc. For training complex deep learning models, significant compute, memory, and data exchange capacities are required to achieve reasonable timelines. Distributed training architectures decompose workloads across modeling training hosts 1020 to accelerate development. Pipeline orchestration maximizes utilization of available resources.

Retraining can incrementally incorporate new field data to consistently strengthen model generalization. The trained models are then deployed to user equipment which utilize the machine learning based delay spread and PETL values for efficient channel estimation. The modular components 1022, 1024, and 1026 of modeling training host 1020 enable cost-efficient scaling on demand to meet evolving training data and model complexity needs through the lifecycle. The high-level model training workflow exemplified via modeling training host 1020 is shareable across wireless functionality that rely on optimized dynamic decision making by AI assistants including beam selection, power control etc. Beyond channel parameter prediction discussed earlier, modeling training host 1020 represents a capability set realizable via commercial off-the-shelf servers leveraging their advancing base hardware combined with ML libraries and frameworks to deliver sophisticated learning solutions tackling wireless communication challenges through autonomous data-driven modeling.

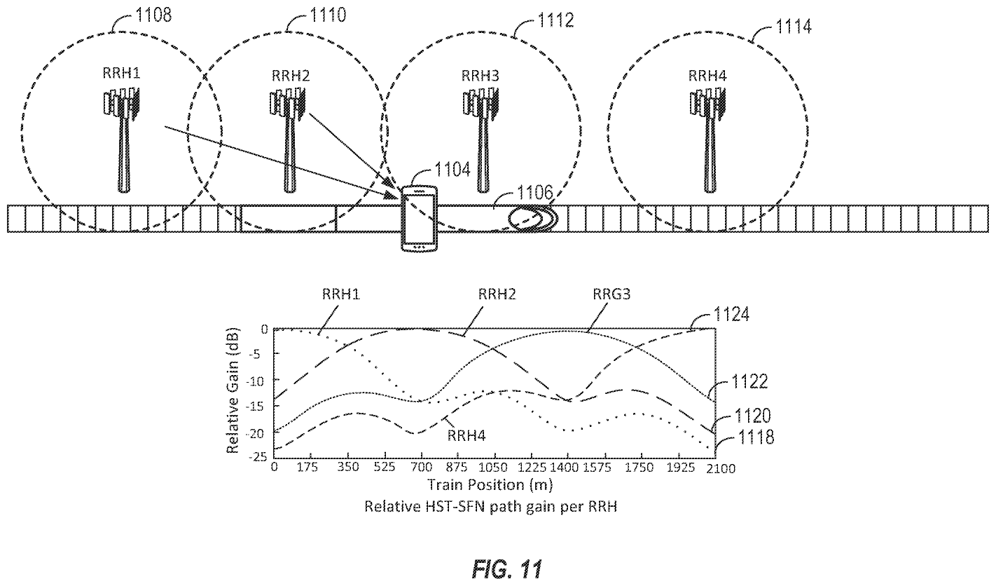

FIG. 11 illustrates an example high-speed train single frequency network (HST-SFN) scenario showing relative path gains from multiple radio remote heads (RRHs) as a function of train position over time. In the depicted HST-SFN deployment, UE 1104 located on a high-speed train 1106 is served by RRHs 1108, 1110, 1112 and 1114 strategically installed along the train track infrastructure. Each RRH transmits similar reference and data signals towards the in-motion train across the dynamically varying wireless channel. In examples, the RRHs 1108, 1110, 1112, and 1114 may be implemented as a base station 102.

However due to rapid UE movement, the specific multipath propagation traits such as tapped delay line parameters frequently change. The channel evolution over time can lead to relative path gains 1118, 1120, 1122, and 1124 plotted for each RRH 1108-1114 respectively across the entire train 1106 trajectory. At any point, the path gain represents channel energy received from a particular RRH's transmitted signal. It can be observed that each RRH's contribution rises when UE 1104 is near the RRH and falls as the train 1106 advances farther away. The time-varying channel characteristics pose challenges for delay spread and PETL estimation which rely on channel snapshots that may not reflect current propagation traits.

The time-varying tap movements directly impact delay spread and PETL calculations, which rely on channel impulse response estimates from earlier referenced symbols. Since previously received and stored TRS or SSB signal waveforms may be utilized, they may not accurately represent current channel dynamics experienced by later data transmissions-especially prevalent at high velocities. This disconnect between lagged channel snapshots versus instantaneous propagation traits is more prevalent in high mobility scenarios, such as where a UE 1104 is moving rapidly.

For example, in highly dynamic environments like HST-SFN, the channel tap distribution varies rapidly as a train 1106 covers distance. Outdated CSI leads to suboptimal delay spread and PETL calculations. The centered delay window can miss capturing energy contributions from current strong taps. Ultimately this translates to distorted channel estimates and higher data error rates.

In some examples, the machine learning model approach to estimating delay spread and/or PETL can be utilized in predictive channel delay tracking scenarios, where the evolution, or change over time, of the channel tap energy can be forecasted by analyzing prior channel impulse response tap clusters, their transitions and current mobility state. Accordingly, future delay profiles within a prediction interval can be estimated to align processing to channel variations occurring in real-time or near real-time. In some examples, the delay spread and PETL ML models can be modified to account for likely tap movements—for example training a machine learning model using left/right shifted tap delay profiles to improve generalization. In some examples, the PETL threshold can be scaled back in HST conditions to increase margins around detected strong taps, allowing more room for taps to shift before dropping out of centered delay spread window. In some examples, the delay spread and PETL outputs can be mathematically represented as functions of physical context like Doppler shifts or UE acceleration which can be captured from navigation systems; such representations can be used to track channel variability. In some examples, non-uniform power delay profile basis functions like exponential taps can be used to better match HST channels instead of using legacy uniform PDP assumptions to improve channel approximation accuracy. The proposed machine learning framework helps address these challenges by dynamically predicting delay parameters based on indicators like Doppler shifts to improve channel estimation resiliency and throughput gains in highly mobile conditions like HST-SFNs.

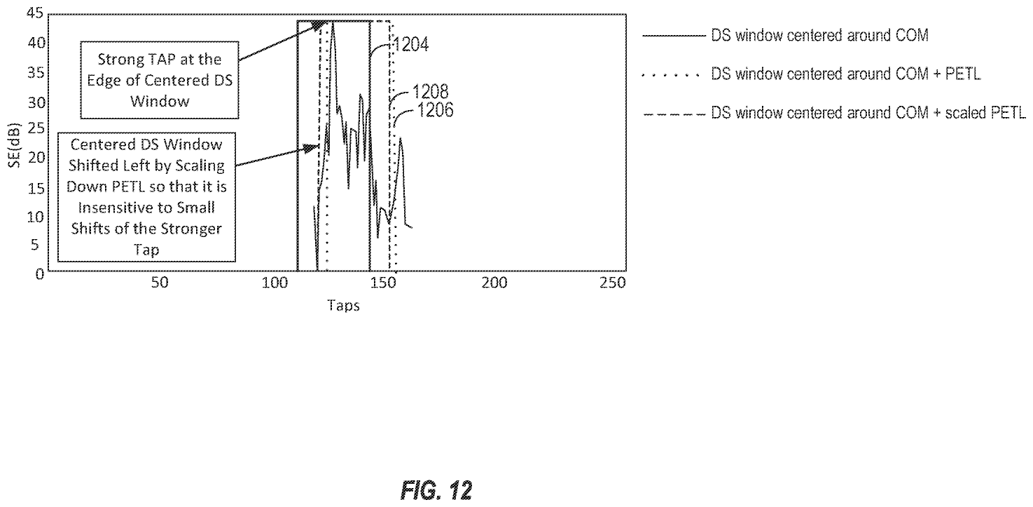

FIG. 12 illustrates an example directed to generating a (PETL) parameter to help the delay spread window account for channel tap shifts in a high-speed train scenario. As discussed previously and shown in FIG. 11, the rapid mobility HST-SFN causes the CIR taps to shift dynamically, reducing the accuracy of delay spread calculations that rely on earlier CSI. Relative path gains from multiple RRHs to a UE can vary significantly based on train position. To address this variation, the PETL value can be scaled down (e.g., 1208) to provide additional margin around detected strong taps. As depicted in FIG. 12, the delay spread window 1206 based on PETL may be positioned next to a strong tap. 1204 depicts the delay spread window centered on COM. By reducing PETL, the window is shifted left 1208, providing more latitude for taps to shift before falling outside the window which would degrade channel estimation calculations. This provides additional margins for channel taps to shift without moving outside the centered delay spread window and degrading channel estimation accuracy.

In certain aspects, side information such as timestamps and/or Doppler shifts can be utilized by the ML model to help perform channel estimation. That is, the ML model can optimize channel parameters based on additional contextual information (e.g., timestamps, and/or Doppler shifts). The ability of the ML techniques to adapt delay parameters based on mobility trends makes the overall channel estimation process more robust in a rapidly changing environment such as high-speed rail.

### Aspects Related to ML-Based Channel Parameter Estimation in Wireless Communication Systems

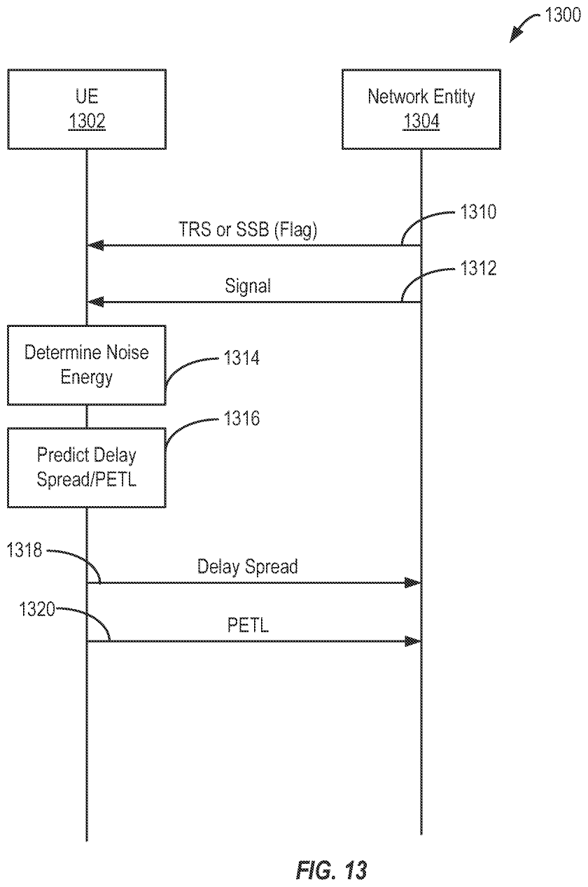

FIG. 13 depicts a process flow 1300 for communications in a network between a network entity 1304 and a UE 1302. In some aspects, the network entity 1304 may be an example of the BS 102 depicted and described with respect to FIGS. 1 and 3 or a disaggregated base station depicted and described with respect to FIG. 2. Similarly, the UE 1302 may be an example of UE 104 depicted and described with respect to FIGS. 1 and 3. However, in other aspects, UE 1302 may be another type of wireless communications device and network entity 1304 may be another type of network entity or network node, such as those described herein.

In this example, the UE 1302 leverages the proposed machine learning framework (e.g., FIGS. 5-7 and 9A-10B) to predict the delay spread and PETL values based on reference signal analysis. These optimized channel parameters are provided to the network entity 1304 prior to data transmission.

In certain aspects, the UE 1302 receives a reference signal 1312 and determines an amount of noise energy 1314 associated with the received reference signal 1312. As previously discussed, the UE utilizes an ML model to predict 1316 the delay spread (e.g., delay spread index) and/or PETL from one or more reference signals 1312. In some examples, a flag 1310 may be received or otherwise utilized during the determination of the delay spread and PETL at 1312.

The UE may provide the predicted delay spread 1318 (e.g., as a delay spread index) and PETL 1320 (e.g., and/or a basis matrix rotation value) parameters to the network entity 1304 prior to data transmission by the network entity 1304. This enables the network entity 1304 to adapt transmission parameters based on channel conditions reported by the UE 1302. For example, if the delay spread is large, finer precoding granularity may be used for better frequency selectivity. The network entity 1304 may also modify DMRS patterns to higher density pilots in frequency if the channel is more frequency selective. In certain aspects, continuous retraining of the machine learning model will allow further customization of the delay spread and PETL predictions at UE 1302 as well as the network entity 1304 scheduling policy using these inputs.

### Example Operations of a User Equipment

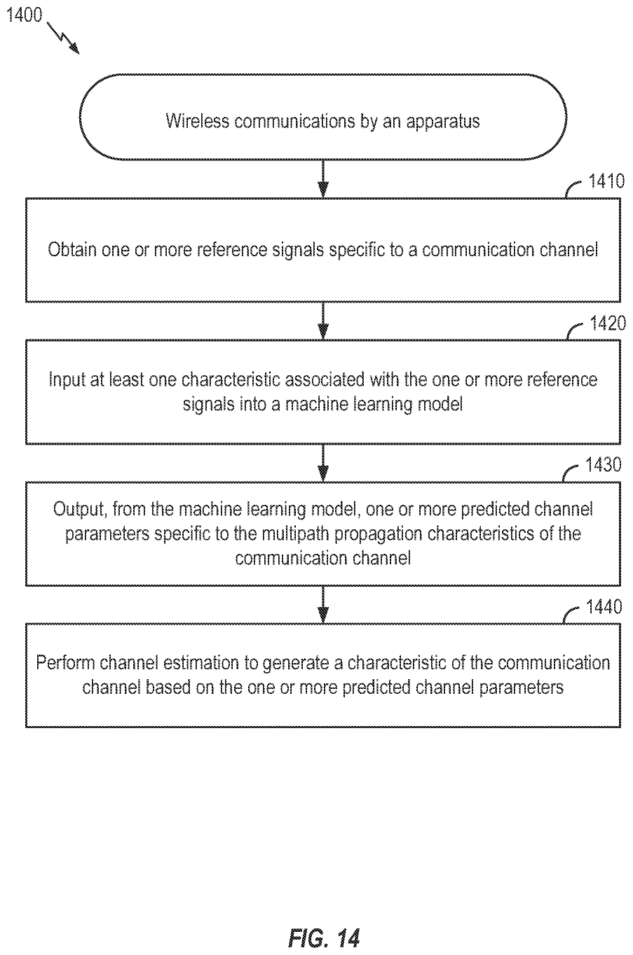

FIG. 14 shows a method 1400 for wireless communications by a UE, such as UE 104 of FIGS. 1 and 3.

Method 1400 begins at block 1410 with obtaining one or more reference signals specific to a communication channel.

Method 1400 then proceeds to block 1420 with inputting at least one characteristic associated with the one or more reference signals into a machine learning model that is configured to predict one or more channel parameters associated with multipath propagation characteristics of the communication channel.

Method 1400 then proceeds to block 1430 with outputting, from the machine learning model, one or more predicted channel parameters specific to the multipath propagation characteristics of the communication channel.

Method 1400 then proceeds to block 1440 with performing channel estimation to generate a characteristic of the communication channel based on the one or more predicted channel parameters.

In one aspect, the one or more predicted channel parameters include at least one of an estimated delay spread associated with a) the communication channel or b) a channel impulse response centering parameter.

In one aspect, the one or more reference signals include at least one of a tracking reference signal, a synchronization signal block, or a channel state information reference signal.

In one aspect, the at least one characteristic associated with the one or more reference signals includes at least one of signal energy of the one or more reference signals or noise energy of the one or more reference signals.

In one aspect, method 1400 further includes inputting, into the machine learning model, at least one of: a characteristic associated with a modulation and coding scheme, a characteristic of a demodulation reference signal, a channel rank, a number of transmit ports at a node used for transmitting channel state information reference signals, a sounding reference signal precoding matrix, or a characteristic associated with a measure of Doppler.

In one aspect, the one or more predicted channel parameters includes an index to a basis matrix and a rotation to apply to the basis matrix.

In one aspect, method 1400 further includes selecting a basis matrix from a plurality of basis matrices based on the one or more predicted channel parameters, wherein the selected basis matrix provides one or more basis vectors that approximate a response of the communication channel.

In one aspect, the plurality of basis matrices comprises at least one basis matrix corresponding to a non-uniform power delay profile.

In one aspect, method 1400 further includes extracting features related to at least one of delay spread, Doppler spread, spatial correlation, or interference characteristics from the reference signals; selecting a subset of features utilizing information gain for predicting channel parameters based on a correlation analysis; and inputting the selected subset of features into the machine learning model.

In one aspect, method 1400 further includes determining a velocity of the apparatus; determining channel conditions including at least a signal-to-noise ratio; and providing the velocity and channel conditions as additional input to the machine learning model.

In one aspect, the velocity of the apparatus is determined using at least of a global position system (GPS) or a Doppler shift.

In one aspect, method 1400 further includes detecting that the apparatus is moving; and in response to detecting that the apparatus is moving, applying one or more corrections to the predicted channel parameters to account for time variations in the channel.

In one aspect, applying one or more corrections to the predicted channel parameters comprises at least one of reducing a predicted delay spread window length or modifying a channel impulse response centering parameter.

In one aspect, method 1400 further includes transmitting information indicative of the predicted channel parameters to a network entity, wherein the information indicative of the predicted channel parameters is utilized by the network entity to configure one or more transmission parameters comprising at least one of a number of orthogonal frequency division multiplexing symbols, a precoder matrix indicator, a rank indicator, or a modulation and coding scheme.

In one aspect, method 1400 further includes providing feedback to a network entity based on the one or more predicted channel parameters.

In one aspect, method 1400 further includes receiving an indication, from the network entity, to adapt at least one transmission parameter based on the feedback.

In one aspect, adapting the at least one transmission parameter comprises adapting at least one of a precoding matrix, a precoding matrix granularity, a demodulation reference signal pattern, a number of transmission ports, or a transmission beam direction.

In one aspect, method 1400 further includes predicting one or more reference signals over multiple time instances.

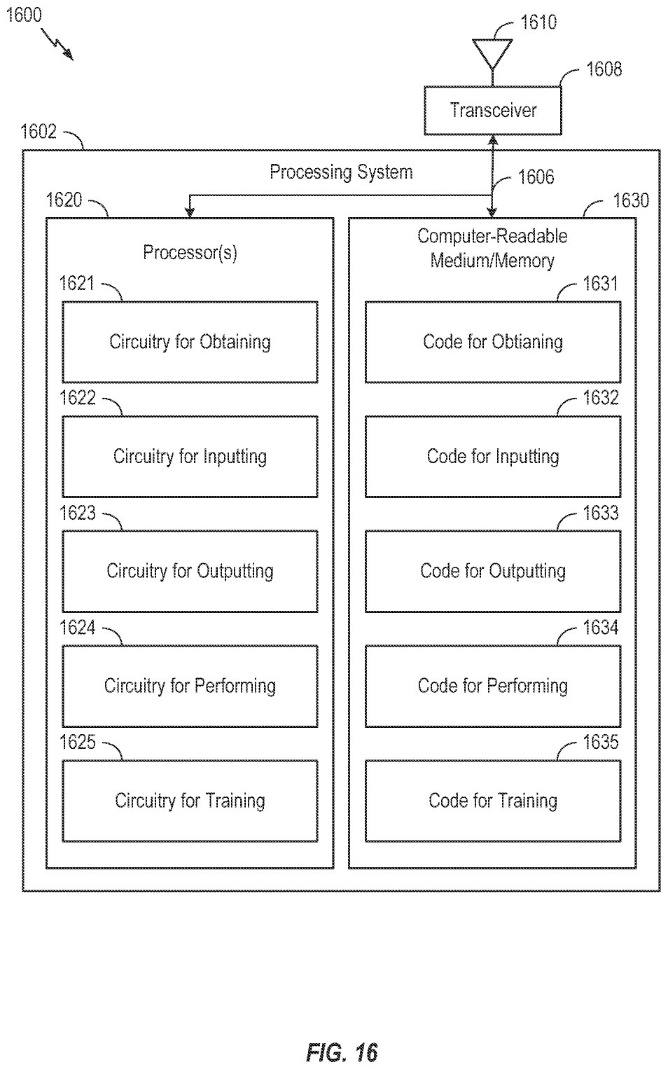

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

### Example Operations of a Network Entity

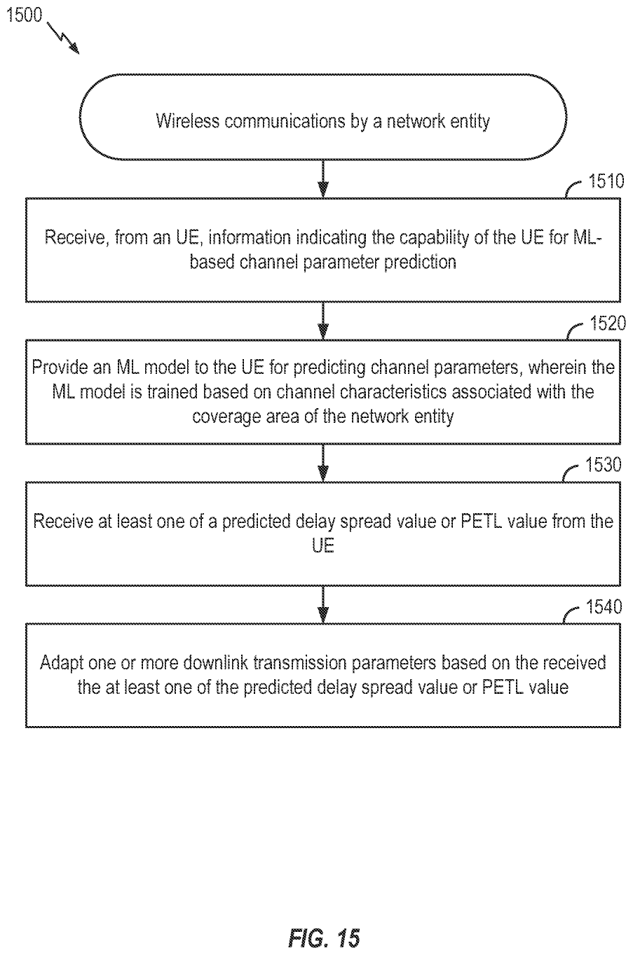

FIG. 15 shows a method 1500 for wireless communications by a network entity, such as BS 102 of FIGS. 1 and 3, or a disaggregated base station as discussed with respect to FIG. 2.

Method 1500 begins at block 1510 with receiving, from an UE, information indicating the capability of the UE for ML-based channel parameter prediction.

In one aspect, the information indicates whether the capability is activated.

Method 1500 then proceeds to block 1520 with providing an ML model to the UE for estimating channel parameters.

In one aspect, method 1500 further comprises training the ML model on channel characteristics associated with the coverage area of the network entity.

Method 1500 then proceeds to block 1530 with receiving at least one of a predicted delay spread value or PETL value from the UE.

In one aspect, the at least one of the predicted delay spread value or PETL value are based on the provided ML model.

Method 1500 then proceeds to block 1540 with adapting one or more downlink transmission parameters based on the received the at least one of the predicted delay spread value or PETL value.

In some aspects, method 1500 further comprises collecting channel measurement data from one or more UEs and transmitting the channel measurement data to a model server.

In some aspects, method 1500 further comprises receiving a model update from the model server.

In some aspects, method 1500 further comprises providing the model update to the UE.

In some aspects, method 1500 further comprises aggregating channel measurement data from multiple network entities.

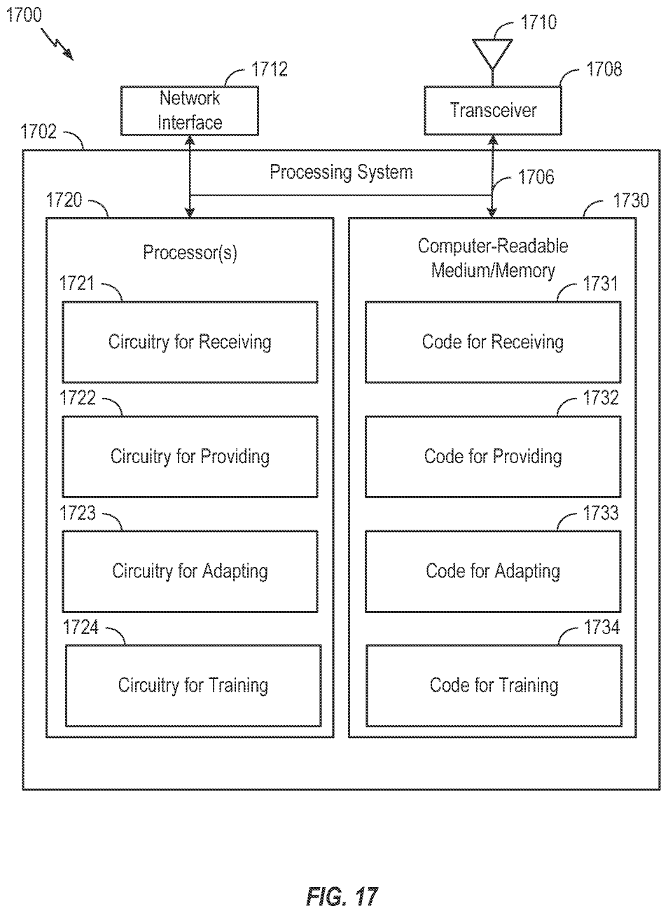

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Communications Devices

FIG. 16 depicts aspects of an example communications device 1600. In some aspects, communications device 1600 is a user equipment, such as UE 104 described above with respect to FIGS. 1 and 3.

The communications device 1600 includes a processing system 1602 coupled to a transceiver 1608 (e.g., a transmitter and/or a receiver). The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes one or more processors 1620. In various aspects, the one or more processors 1620 may be representative of one or more of receive processor 358, transmit processor 364, TX MIMO processor 366, and/or controller/processor 380, as described with respect to FIG. 3. The one or more processors 1620 are coupled to a computer-readable medium/memory 1630 via a bus 1606. In certain aspects, the computer-readable medium/memory 1630 is configured to store instructions (e.g., computer-executable code) that when executed by the one or more processors 1620, cause the one or more processors 1620 to perform the method 1400 described with respect to FIG. 14, or any aspect related to it, including any operations described in relation to FIG. 14. Note that reference to a processor performing a function of communications device 1600 may include one or more processors performing that function of communications device 1600, such as in a distributed fashion.

In the depicted example, computer-readable medium/memory 1630 stores code (e.g., executable instructions) for obtaining 1631, code for inputting 1632, code for outputting 1633, code for performing 1634, and code for training a ML model 1635. Processing of the code 1631-1635 may enable and cause the communications device 1600 to perform the method 1400 described with respect to FIG. 14, or any aspect related to it.

The one or more processors 1620 include circuitry configured to implement (e.g., execute) the code stored in the computer-readable medium/memory 1630, including circuitry for obtaining 1621, circuitry for inputting 1622, circuitry for outputting 1623, circuitry for performing 1624, and circuitry for training a ML model 1625. Processing with circuitry 1621-1625 may enable and cause the communications device 1600 to perform the method 1400 described with respect to FIG. 14, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1608 and/or antenna 1610 of the communications device 1600 in FIG. 16, and/or one or more processors 1620 of the communications device 1600 in FIG. 16. Means for communicating, receiving or obtaining may include the transceivers 354, antenna(s) 352, receive processor 358, AI processor 370, and/or controller/processor 380 of the UE 104 illustrated in FIG. 3, transceiver 1608 and/or antenna 1610 of the communications device 1600 in FIG. 16, and/or one or more processors 1620 of the communications device 1600 in FIG. 16.

FIG. 17 depicts aspects of an example communications device. In some aspects, communications device 1700 is a network entity, such as BS 102 of FIGS. 1 and 3, or a disaggregated base station as discussed with respect to FIG. 2.

The communications device 1700 includes a processing system 1702 coupled to a transceiver 1708 (e.g., a transmitter and/or a receiver) and/or a network interface 1712. The transceiver 1708 is configured to transmit and receive signals for the communications device 1700 via an antenna 1710, such as the various signals as described herein. The network interface 1712 is configured to obtain and send signals for the communications device 1700 via communications link(s), such as a backhaul link, midhaul link, and/or fronthaul link as described herein, such as with respect to FIG. 2. The processing system 1702 may be configured to perform processing functions for the communications device 1700, including processing signals received and/or to be transmitted by the communications device 1700.

The processing system 1702 includes one or more processors 1720. In various aspects, one or more processors 1720 may be representative of one or more of receive processor 338, transmit processor 320, TX MIMO processor 330, and/or controller/processor 340, as described with respect to FIG. 3. The one or more processors 1720 are coupled to a computer-readable medium/memory 1730 via a bus 1706. In certain aspects, the computer-readable medium/memory 1730 is configured to store instructions (e.g., computer-executable code), including code aspects 1731-1734, that when executed by the one or more processors 1720, cause the one or more processors 1720 to perform the method 1500 described with respect to FIG. 15, or any aspect related to it, including any operations described in relation to FIG. 15. Note that reference to a processor of communications device 1700 performing a function may include one or more processors of communications device 1700 performing that function, such as in a distributed fashion.

In the depicted example, the computer-readable medium/memory 1730 stores code (e.g., executable instructions) for receiving 1731, code for providing 1732, code for adapting 1733, and code for training 1734. Processing of the code 1731-1734 may enable and cause the communications device 1700 to perform the method 1500 described with respect to FIG. 15, or any aspect related to it.

The one or more processors 1720 include circuitry configured to implement (e.g., execute) the code stored in the computer-readable medium/memory 1730, including circuitry for receiving 1721, circuitry for providing 1722, circuitry for adapting 1723, and circuitry for training 1724. Processing with circuitry 1721-1724 may enable and cause the communications device 1700 to perform the method 1500 as described with respect to FIG. 15, or any aspect related to it.

Various components of the communications device 1700 may provide means for performing the method 1500 as described with respect to FIG. 15, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1708, antenna 1710, and/or network interface 1712 of the communications device 1700 in FIG. 17, and/or one or more processors 1720 of the communications device 1700 in FIG. 17. Means for communicating, receiving or obtaining may include the transceivers 332, antenna(s) 334, receive processor 338, AI processor 318, and/or controller/processor 340 of the BS 102 illustrated in FIG. 3, transceiver 1708, antenna 1710, and/or network interface 1712 of the communications device 1700 in FIG. 17, and/or one or more processors 1720 of the communications device 1700 in FIG. 17. For example, means for collecting and aggregating of the method 1500 described with respect to FIG. 15, or any aspect related to it, may include collecting means and aggregating means.

### Example Clauses

Implementation examples are described in the following numbered clauses:

Clause 1: A method for generating a characteristic of a communication channel based on one or more predicted channel parameters, the method comprising: obtaining one or more reference signals specific to a communication channel; inputting at least one characteristic associated with the one or more reference signals into a machine learning model that is configured to predict one or more channel parameters associated with multipath propagation characteristics of the communication channel; outputting, from the machine learning model, one or more predicted channel parameters specific to the multipath propagation characteristics of the communication channel; and performing channel estimation to generate a characteristic of the communication channel based on the one or more predicted channel parameters.

Clause 2: The method according to Clause 1, wherein the one or more predicted channel parameters include at least one of an estimated delay spread associated with a) the communication channel or b) a channel impulse response centering parameter.

Clause 3: The method according to any one of Clauses 1-2, wherein the one or more reference signals include at least one of a tracking reference signal, a synchronization signal block, or a channel state information reference signal.

Clause 4: The method according to any one of Clauses 2-3, wherein the at least one characteristic associated with the one or more reference signals includes at least one of signal energy of the one or more reference signals or noise energy of the one or more reference signals.

Clause 5: The method according to Clause 4, further comprising: inputting, into the machine learning model, at least one of: a characteristic associated with a modulation and coding scheme, a characteristic of a demodulation reference signal, a channel rank, a number of transmit ports at a node used for transmitting channel state information reference signals, a sounding reference signal precoding matrix, or a characteristic associated with a measure of Doppler.

Clause 6: The method according to any one of Clauses 1-5, wherein the one or more predicted channel parameters includes an index to a basis matrix and a rotation to apply to the basis matrix.

Clause 7: The method according to any one of Clauses 1-6, further comprising selecting a basis matrix from a plurality of basis matrices based on the one or more predicted channel parameters, wherein the selected basis matrix provides one or more basis vectors that approximate a response of the communication channel.

Clause 8: The method according to Clause 7, wherein the plurality of basis matrices comprises at least one basis matrix corresponding to a non-uniform power delay profile.

Clause 9: The method according to any one of Clauses 1-8, further comprising: extracting features related to at least one of delay spread, Doppler spread, spatial correlation, or interference characteristics from the reference signals; selecting a subset of features utilizing information gain for predicting channel parameters based on a correlation analysis; and inputting the selected subset of features into the machine learning model.

Clause 10: The method according to any one of Clauses 1-9, further comprising: determining a velocity of the apparatus; determining channel conditions including at least a signal-to-noise ratio; and providing the velocity and channel conditions as additional input to the machine learning model.

Clause 11: The method according to Clause 10, wherein the velocity of the apparatus is determined using at least of a global position system (GPS) or a Doppler shift.

Clause 12: The method according to any one of Clauses 1-11, further comprising: detecting that the apparatus is moving; and in response to detecting that the apparatus is moving, applying one or more corrections to the predicted channel parameters to account for time variations in the channel.

Clause 13: The method according to Clause 12, wherein applying one or more corrections to the predicted channel parameters comprises at least one of reducing a predicted delay spread window length or modifying a channel impulse response centering parameter.

Clause 14: The method according to any one of Clauses 1-13, further comprising transmitting information indicative of the predicted channel parameters to a network entity, wherein the information indicative of the predicted channel parameters is utilized by the network entity to configure one or more transmission parameters comprising at least one of a number of orthogonal frequency division multiplexing symbols, a precoder matrix indicator, a rank indicator, or a modulation and coding scheme.

Clause 15: The method according to any one of Clauses 1-14, further comprising providing feedback to a network entity based on the one or more predicted channel parameters.

Clause 16: The method according to Clause 15, further comprising receiving an indication, from the network entity, to adapt at least one transmission parameter based on the feedback.

Clause 17: The method according to Clause 16, wherein adapting the at least one transmission parameter comprises adapting at least one of a precoding matrix, a precoding matrix granularity, a demodulation reference signal pattern, a number of transmission ports, or a transmission beam direction.

Clause 18: The method according to any one of Clauses 1-17, further comprising predicting one or more reference signals over multiple time instances.

Clause 19: A method for adapting one or more transmission parameters, the method comprising: receiving, from an UE, information indicating the capability of the UE for ML-based channel parameter prediction; providing an ML model to the UE for estimating channel parameters; receiving at least one of a predicted delay spread value or PETL value from the UE; and adapting one or more downlink transmission parameters based on the received the at least one of the predicted delay spread value or PETL value.

Clause 20: The method according to Clause 19, wherein the information indicates whether the capability is activated.

Clause 21: The method according to any one of Clauses 19-20, further comprising training the ML model on channel characteristics associated with the coverage area of the network entity.

Clause 22: The method according to any one of Clauses 19-21, wherein the at least one of the predicted delay spread value or PETL value are based on the provided ML model.

Clause 23: The method according to any one of Clauses 19-22, further comprising collecting channel measurement data from one or more UEs and transmitting the channel measurement data to a model server.

Clause 24: The method according to Clause 23, further comprising receiving a model update from the model server.

Clause 25: The method according to Clause 24, further comprising providing the model update to the UE.

Clause 26: The method according to any one of Clauses 19-25, further comprising aggregating channel measurement data from multiple network entities.

Clause 27: One or more apparatuses, comprising: one or more memories comprising executable instructions; and one or more processors configured to execute the executable instructions and cause the one or more apparatuses to perform a method in accordance with any one of clauses 1-26.

Clause 28: One or more apparatuses, comprising: one or more memories; and one or more processors, coupled to the one or more memories, configured to cause the one or more apparatuses to perform a method in accordance with any one of Clauses 1-26.

Clause 29: One or more apparatuses, comprising: one or more memories; and one or more processors, coupled to the one or more memories, configured to perform a method in accordance with any one of Clauses 1-26.

Clause 30: One or more apparatuses, comprising means for performing a method in accordance with any one of Clauses 1-26.

Clause 31: One or more non-transitory computer-readable media comprising executable instructions that, when executed by one or more processors of one or more apparatuses, cause the one or more apparatuses to perform a method in accordance with any one of Clauses 1-26.

Clause 32: One or more computer program products embodied on one or more computer-readable storage media comprising code for performing a method in accordance with any one of Clauses 1-26.

Clause 33: A user equipment (UE), comprising: a processing system that includes processor circuitry and memory circuitry that stores code and is coupled with the processor circuitry, the processing system configured to cause the UE to perform a method in accordance with any one of Clauses 1-18.

Clause 34: A network entity, comprising: a processing system that includes processor circuitry and memory circuitry that stores code and is coupled with the processor circuitry, the processing system configured to cause the network entity to perform a method in accordance with any one of Clauses 19-26.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories comprising processor-executable instructions; and
one or more processors configured to execute the processor-executable instructions and cause the apparatus to:
obtain one or more reference signals specific to a communication channel;
input at least one characteristic associated with the one or more reference signals into a machine learning model that is configured to predict one or more channel parameters associated with multipath propagation characteristics of the communication channel;
output, from the machine learning model, one or more predicted channel parameters specific to the multipath propagation characteristics of the communication channel; and
perform channel estimation to generate a characteristic of the communication channel based on the one or more predicted channel parameters.

2. The apparatus of claim 1, wherein the one or more predicted channel parameters include at least one of an estimated delay spread associated with a) the communication channel or b) a channel impulse response centering parameter.

3. The apparatus of claim 2, wherein the at least one characteristic associated with the one or more reference signals includes at least one of signal energy of the one or more reference signals or noise energy of the one or more reference signals.

4. The apparatus of claim 3, wherein the one or more processors are configured to cause the apparatus to input, into the machine learning model, at least one of: a characteristic associated with a modulation and coding scheme, a characteristic of a demodulation reference signal, a channel rank, a number of transmit ports at a node used for transmitting channel state information reference signals, a sounding reference signal precoding matrix, or a characteristic associated with a measure of Doppler.

5. The apparatus of claim 1, wherein the one or more predicted channel parameters includes an index to a basis matrix and a rotation to apply to the basis matrix.

6. The apparatus of claim 1, wherein the one or more processors are configured to cause the apparatus to select a basis matrix from a plurality of basis matrices based on the one or more predicted channel parameters, wherein the selected basis matrix provides one or more basis vectors that approximate a response of the communication channel.

7. The apparatus of claim 6, wherein the plurality of basis matrices comprises at least one basis matrix corresponding to a non-uniform power delay profile.

8. The apparatus of claim 1, wherein the one or more processors are configured to cause the apparatus to:
extract features related to at least one of delay spread, Doppler spread, spatial correlation, or interference characteristics from the reference signals;
select a subset of features utilizing information gain for predicting channel parameters based on a correlation analysis; and
input the selected subset of features into the machine learning model.

9. The apparatus of claim 1, wherein the one or more processors are configured to cause the apparatus to:
determine a velocity of the apparatus;
determine channel conditions including at least a signal-to-noise ratio; and
provide the velocity and channel conditions as additional input to the machine learning model.

10. The apparatus of claim 9, wherein the velocity of the apparatus is determined using at least of a global position system (GPS) or a Doppler shift.

11. The apparatus of claim 1, wherein the one or more processors are configured to cause the apparatus to:
detect that the apparatus is moving; and
in response to detecting that the apparatus is moving, apply one or more corrections to the predicted channel parameters to account for time variations in the channel.

12. The apparatus of claim 11, wherein to apply one or more corrections to the predicted channel parameters comprises at least one of to reduce a predicted delay spread window length or to modify a channel impulse response centering parameter.

13. The apparatus of claim 1, wherein the one or more processors are configured to cause the apparatus to transmit information indicative of the predicted channel parameters to a network entity, wherein the information indicative of the predicted channel parameters is utilized by the network entity to configure one or more transmission parameters comprising at least one of a number of orthogonal frequency division multiplexing symbols, a precoder matrix indicator, a rank indicator, or a modulation and coding scheme.

14. The apparatus of claim 1, wherein the one or more processors are configured to cause the apparatus to:
determine a delay spread feedback report based on the one or more predicted channel parameters; and
transmit the delay spread feedback report to a network entity to adapt one or more downlink transmission parameters comprising at least one of a precoder matrix indicator, a rank indictor, or a modulation and coding scheme.

15. The apparatus of claim 1, wherein the one or more processors are configured to cause the apparatus to provide feedback to a network entity based on the one or more predicted channel parameters.

16. The apparatus of claim 15, wherein the one or more processors are configured to cause the apparatus to receive an indication, from the network entity, to adapt at least one transmission parameter based on the feedback.

17. The apparatus of claim 16, wherein to adapt the at least one transmission parameter comprises to adapt at least one of a precoding matrix, a precoding matrix granularity, a demodulation reference signal pattern, a number of transmission ports, or a transmission beam direction.

18. The apparatus of claim 1, wherein the one or more processors are configured to cause the apparatus to predict one or more reference signals over multiple time instances.

19. A method for generating a characteristic of a communication channel based on one or more predicted channel parameters, the method comprising:
obtaining one or more reference signals specific to a communication channel;
inputting at least one characteristic associated with the one or more reference signals into a machine learning model that is configured to predict one or more channel parameters associated with multipath propagation characteristics of the communication channel;
outputting, from the machine learning model, one or more predicted channel parameters specific to the multipath propagation characteristics of the communication channel; and
performing channel estimation to generate a characteristic of the communication channel based on the one or more predicted channel parameters.

20. An apparatus configured for wireless communications, comprising:
one or more memories comprising processor-executable instructions; and
one or more processors configured to execute the processor-executable instructions and cause the apparatus to:
obtain one or more reference signals specific to a communication channel;
input at least one characteristic associated with the one or more reference signals into a machine learning model that is configured to predict one or more channel parameters associated with multipath propagation characteristics of the communication channel;
output, from the machine learning model, one or more predicted channel parameters specific to the multipath propagation characteristics of the communication channel; and
provide feedback to a network entity based on the one or more predicted channel parameters.
